(19) United States
(12) Patent Application Publication
(10) Pub. No.: US 2008/0088797 A1
(43) Pub. Date: Apr. 17, 2008

(54) MOBILE IMAGE DISPLAY UNIT

(76) Inventor: Adam Salacuse, Northampton, MA (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/749,576

(22) Filed: May 16, 2007

Related U.S. Application Data
(60) Provisional application No. 60/829,647, filed on Oct. 16, 2006.

(51) Int. Cl. G03B 21/10

(52) U.S. Cl. 352/104

(57) ABSTRACT

A mobile video display unit comprises a rear projection unit that projects at least one image onto a collapsible screen that surrounds the projection unit to permit viewing within a 360 degree radius of the unit. The collapsible screen can be perforated to permit air to diffuse through its surface and thereby providing resistance to wind loading.

This application claims priority pursuant to 35 U.S.C. 119(e) from U.S. Provisional Application having Application No. 60/829,647 filed Oct. 16, 2006.

### BACKGROUND OF THE INVENTION

1. Field of the Invention

The present invention relates to mobile advertising displays for mounting on a vehicle.

2. Description of the Related Art

Mobile advertising billboards are ubiquitous and can be seen installed on the back of flatbed trucks, towed behind vehicles, or integrated into vehicles of all types. These mobile forms of advertising have become an integral part of our daily lives and now represent an important method of mass communication. Mobile billboards are seen in various other forms such as vinyl banners affixed to the side of a truck, billboard trailers towed by vehicles, and plastic illuminated two-sided signs on the top of a taxicabs.

Certain taxicab advertising billboards integrate programmable mini-electronic billboards that can display a static message, a dynamic message, or a string of messages depending on how the sign is programmed. Larger scale versions of these electronic billboards can be found on the sides of blimps.

Another variation on the mobile electronic billboard is the mobile electronic billboard truck. These trucks utilize the latest in video technology such as large projection TVs, plasma screens, and Liquid crystal displays (LCDs) to deliver video advertisements to consumers on the street. Implementation of these video technologies as mobile billboards is commonly seen in the form of a truck having one or more large screens permanently affixed to it. Having LCD, projection, and/or plasma screens installed as a permanent fixture of a vehicle has some drawbacks however. Firstly, a permanent mobile electronic billboard installation on a truck is not portable and does not permit the billboard to be transported from one vehicle to another if needed (as in the case of a vehicle breaking down). Another drawback of a permanently installed mobile video billboard is that the type of vehicle being utilized may not be complementary to specific billboard advertisements (such as an advertisement for Ford on a GM video billboard truck). Moreover, in a permanent installation, moving the billboard between markets is costly and unwieldy since the entire vehicle has to be relocated to each market where an advertising initiative is being executed.

Lastly, if a mobile billboard is permanently installed as part of a vehicle, views of the billboard are restricted to only three possible pedestrian viewing sides (i.e. the rear, left side and right side of the vehicle) because the front cab of the truck prevents a front viewing angle.

There is a need, therefore, for a mobile video billboard that obviates these and other drawbacks of existing mobile video vehicle billboard installations.

### SUMMARY OF THE INVENTION

The present invention provides a mobile image display unit that comprises a self-contained, rear-projection display unit that can be temporarily affixed to the top of a vehicle providing at least about a 360 degree circumferential view of a displayed image, thereby instantly transforming the vehicle into a mobile image display vehicle. Moreover, the mobile image display unit of the present invention can be quickly dismantled for ease of transportation and storage when not in use, or installation on a different vehicle when required. Preferably, the screens are all porous to wind to allow for use in windy conditions.

### BRIEF DESCRIPTION OF THE DRAWINGS

FIG. 1. depicts a side view of a vehicle with the frame of a mobile image display unit in accordance with the present invention mounted on it; and

FIG. 2 depicts a top view of a vehicle with the frame, projectors and screens of a mobile image display unit in accordance with the present invention mounted on it; and

FIG. 3 depicts a side view of a completed installation of a mobile image display unit in accordance with the present invention.

### DETAILED DESCRIPTION OF THE PREFERRED EMBODIMENTS

The present invention is directed toward a self-contained, portable, collapsible mobile image display unit. In a preferred embodiment, the display unit is adapted for mounting on top of a car, Sport Utility Vehicle (SUV), van or other suitable vehicle. When assembled, the mobile image display unit of the present invention creates a display that can be viewed within at least about a 360 degree circumference of the unit and can project an image on one or more viewing screens.

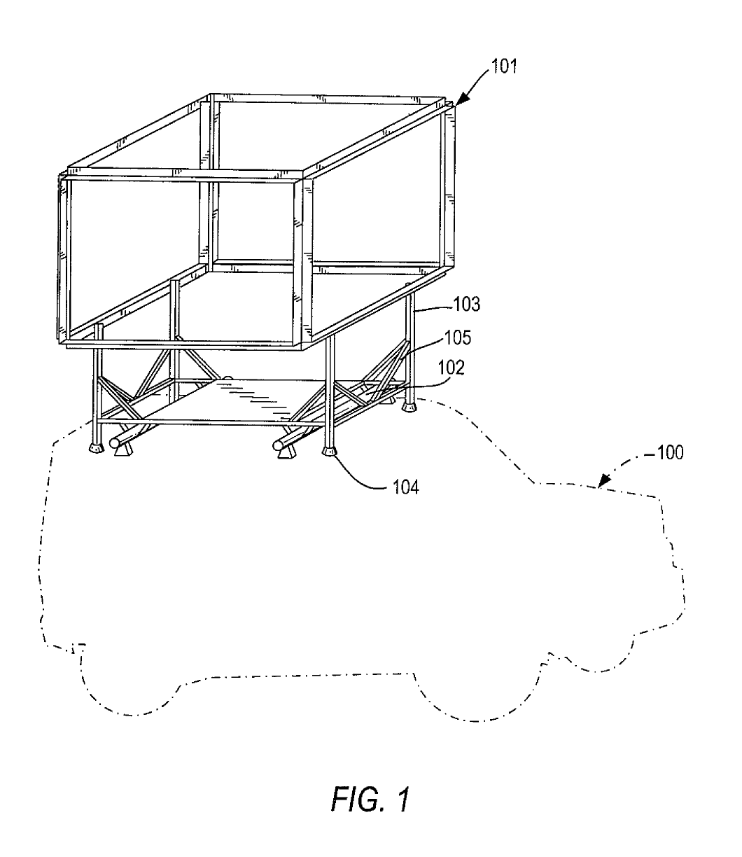

As shown in FIG. 1, a preferred embodiment of a mobile image display unit in accordance with the present invention comprises a frame 101 adapted for mounting on a vehicle 100. Frame 101 comprises a lower portion 103 comprising a sub-frame 105. To attach frame 101 to vehicle 100, mounting bars 102 are first attached to vehicle 100 by a suitable method such as anchoring mounting bars 106 to the roof rails of vehicle 100. Mounting bars 102 are then attached to lower portion 103 by straps 107, thereby anchoring frame 101 to vehicle 100. The mounting surface of vehicle 100 is protected from scratches and abrasions from direct surface contact with frame 101 by rubberized caps attached to the extremities of lower portion 103. Frame 101 is designed to be quickly and easily disassembled, thereby permitting rapid setup and takedown of the mobile image display unit.

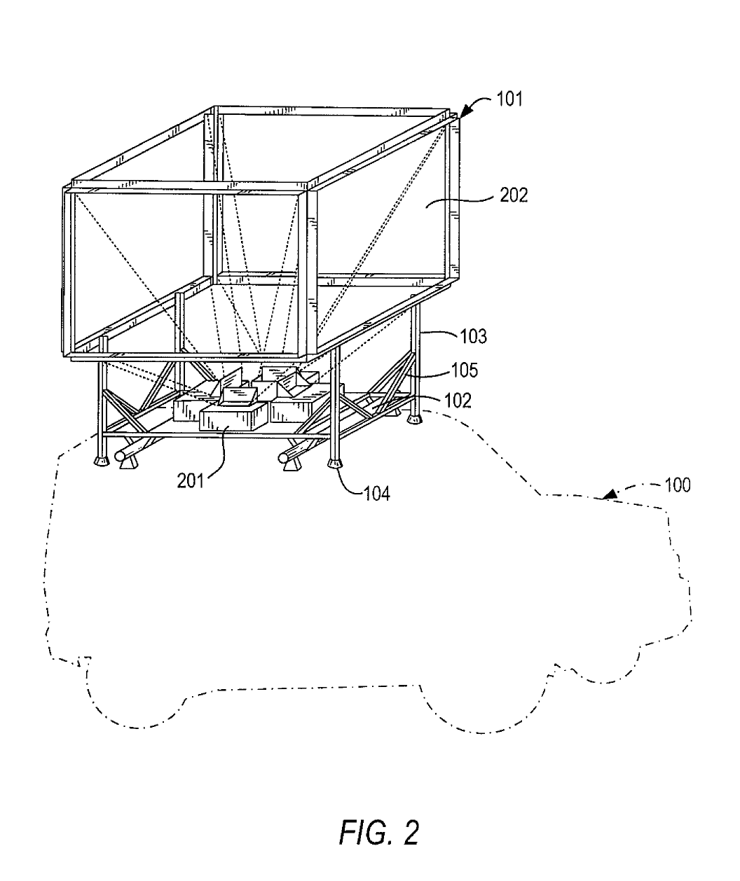

Once frame 101 is anchored in place on vehicle 100, the projection and screen elements of the mobile image display unit of the present invention can be installed. FIG. 2 depicts the projection elements of the present invention as installed on a vehicle 100. As depicted therein, once frame 101 is installed, one or more image projection units 201 are mounted on mounting plate 203. Preferably four separate projection units 201 are utilized for maximum flexibility in programming. Projection units 201 can be adapted for various types of images including still and video images. A single image producer can be used with the ability to project circumferentially.

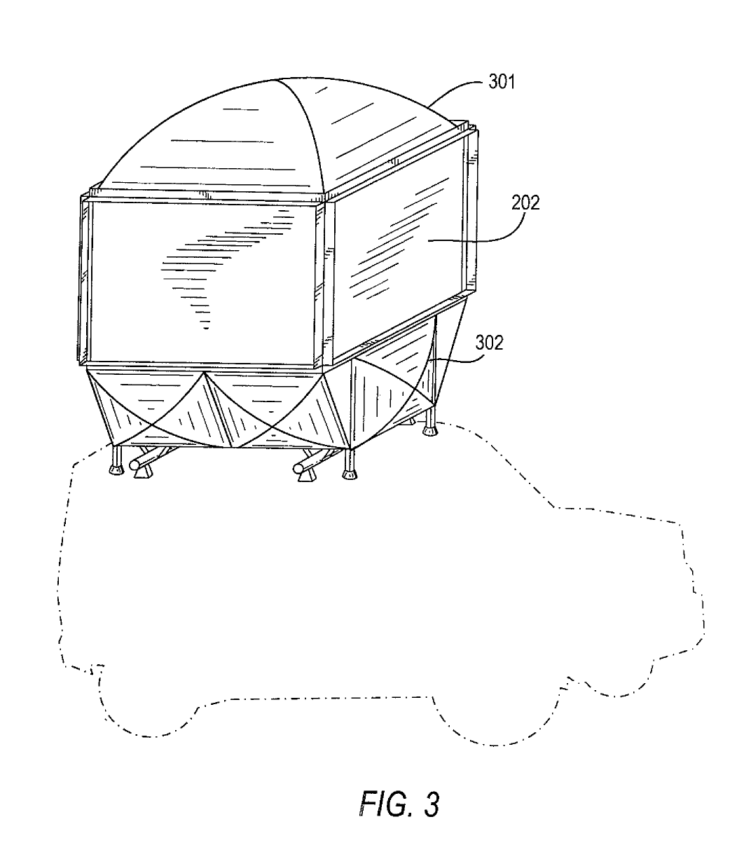

Following installation of projection units 201, screens 202 are inserted into their respective positions within frame 101 as shown. Preferably, the screen is at least two feet in height and most preferably 3 feet high. With this large surface area, preferably screens 202 comprise a porous flexible material that permits air to flow through its surface thereby reducing wind loading on the image display unit. As depicted in FIG. 2, the use of four screens 202 affords a view of the image display within at least a 360-degree circumference of vehicle 100. Referring now to FIG. 3, depicted therein is a fully assembled mobile video billboard 300. As shown in FIG. 3, once the frame assembly 101 is erected and projection units 201 and screens 202 are installed, covers 301 and 302 are installed to shield projection units 201 from the elements. Preferably, covers 301 and 302 are constructed from semi-rigid material that allows water to drain off the top of the assembled unit 300 and prevent infiltration into the projection units 201 housed therein. Alternatively, cover 301 can be replaced by a screen similar to screens 202, thereby allowing an image or video to be projected on top of the image display unit which can be viewed from above the vehicle 100. In operation, the mobile display unit 300 is powered by the vehicie's 100 battery operating in conjunction with a power inverter or generator and is adapted to operate whether the vehicle is stationary or in motion.

While a specific embodiment of the invention has been described in detail, it will be appreciated by those skilled in the art that various modifications and alternatives to those details could be developed in light of the overall teachings of the disclosure. For example frame 101 can be adapted to rotate instead of remaining fixed in place atop vehicle 100. Alternatively, a curved, circular screen can be used, or a three (or more) sided screen. Accordingly, the particular arrangements disclosed are meant to be illustrative only and not limiting as to the scope of the invention which is to be given the full breadth of the appended claims and any and all equivalents thereof.

We claim:

1. A mobile image display unit comprising:
at least one projection surface for displaying images;
a base for removably attaching said projection surface to a vehicle; and
at least one image source, said video source adapted to project at least one video image on said at least one projection surface wherein said at least one projection surface surrounds said image source and displays images projected from said image source when said image source is activated and wherein said at least one projection surface can be viewed within a 360 degree radius of the image display unit.

2. The mobile image display unit according to claim 1 wherein said projection surface is collapsible.

3. The mobile image display unit according to claim 1 wherein said projection surface is a porous flexible screen.

4. The mobile image display unit according to claim 1 wherein said projection surface is an imperforated flexible screen.

5. The mobile image display unit according to claim 1 wherein said at least one image is a video stream.
